(19) United States
(12) Patent Application Publication
(10) Pub. No.: US 2017/0323318 A1
(43) Pub. Date: Nov. 9, 2017

(54) ENTITY-SPECIFIC VALUE OPTIMIZATION TOOL

(71) Applicant: Wal-Mart Stores, Inc., Bentonville, AR (US)

(72) Inventor: Madhur Sarin, Gurgaon (IN)

(21) Appl. No.: 15/188,775

(22) Filed: Jun. 21, 2016

(30) Foreign Application Priority Data
May 9, 2016 (IN) 201641016049

(51) Int. Cl. G06Q 30/02; G06Q 30/06

(52) U.S. Cl. CPC G06Q 30/0206; G06Q 30/0605

(57) ABSTRACT

Examples of the disclosure provide a system and method for entity-specific value optimization. An elasticity estimation module receives a data request for an item associated with an individual entity, and identifies a value response curve for the item associated with the individual entity. The elasticity estimation module determines an elasticity measure for the item associated with the individual entity. A value optimization module dynamically adjusts the identified value response curve for the item associated with the individual entity as new data corresponding to the item and the individual entity is received, and generates a value optimization recommendation based on the dynamic adjustment.

### BACKGROUND

Many environments use elasticity to understand changes in supply and demand, and how these changes may be tied to economic factors such as change in pricing, inflation, and consumer income. Some products or services may be found to be inelastic, meaning that a change in price does not noticeably affect supply or demand for that item. Many factors may impact supply and demand, and these factors may vary across different markets.

### SUMMARY

Examples of the disclosure provide a system and method for entity-specific value optimization. An elasticity estimation module receives a data request for an item associated with an individual entity, and identifies a value response curve for the item associated with the individual entity. The elasticity estimation module determines an elasticity measure for the item associated with the individual entity. A value optimization module dynamically adjusts the identified value response curve for the item associated with the individual entity as new data corresponding to the item and the individual entity is received, and generates a value optimization recommendation based on the dynamic adjustment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for entity-specific value optimization.

FIG. 2 is an exemplary block diagram illustrating an optimization environment for entity-specific elasticity and fair valuation estimations.

FIG. 3 is an exemplary flow diagram illustrating network communication within an optimization environment for entity-specific value optimization.

FIG. 4 is an exemplary flow chart illustrating operation of the computing device to generate a value optimization recommendation for an individual item relative to an individual entity.

FIG. 5 is an exemplary flow chart illustrating operation of the computing device to dynamically generate value optimization recommendations.

FIG. 6 is an exemplary diagram illustrating an optimization environment operating as a cloud-based service.

FIG. 7 is an exemplary block diagram illustrating an operating environment for a computing device implementing developer environment.

Corresponding reference characters indicate corresponding parts throughout the drawings.

### DETAILED DESCRIPTION

Referring to the figures, examples of the disclosure enable entity-specific value optimization for items at an item-entity level. As used herein, an entity may refer to a business entity, such as a retail business for example, and examples are provided that may describe a retail business environment. However, aspects of the disclosure are not limited to a retail or business environment. Elasticity estimation generally focuses on supply and demand for a specific product in the marketplace. Aspects of the disclosure provide for entity-specific elasticity estimation at the item-entity level in order to recommend optimal valuation adjustments for an individual item at an individual store. As used herein, value may refer to a cost or price associated with an item offered for sale, and valuation adjustment may refer to pricing adjustment, for example. Because the valuation recommendation is for a specific item and relative to a specific entity or store, and because the recommendation is directed towards an indication of whether a current item value should be increased, decreased, or maintained for optimal valuation, the item-entity specific elasticity estimation and valuation recommendations are dynamically tailored for each item and store. As used herein, an individual entity may refer to a specific, physical location, such as a physical store location, with each individual entity representing a separate, physical store location within a possible chain of stores, for example.

Aspects of the disclosure further enable increased user interaction performance and user efficiency via user interface interaction because thresholds and entity-specific factors in combination with dynamic data are used to dynamically respond to a data request based on user interface interaction. Automatic alerts, notification, and/or recommendations are generated as new data is obtained, which also contributes to increased user efficiency and reduced error rates, as well as faster processing.

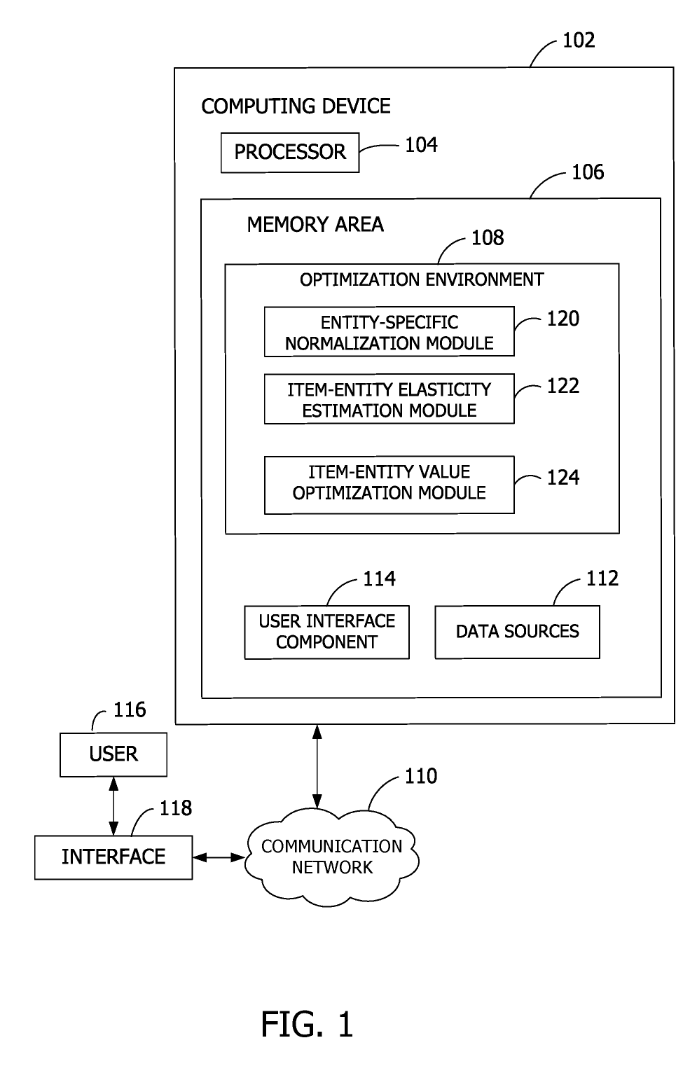

Referring again to FIG. 1, an exemplary block diagram illustrates a computing device for entity-specific value optimization. In the example of FIG. 1, the computing device 102 represents a system for data request processing and entity-specific elasticity estimation for generating entity-specific value optimization recommendations for specific items. As used herein, items refer to products or resources that may be bought and sold, or otherwise part of a value transaction.

The computing device represents any device executing instructions (e.g., as application programs, operating system functionality, or both) to implement the operations and functionality as described herein. The computing device may include a mobile computing device or any other portable device. In some examples, the mobile computing device includes a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices.

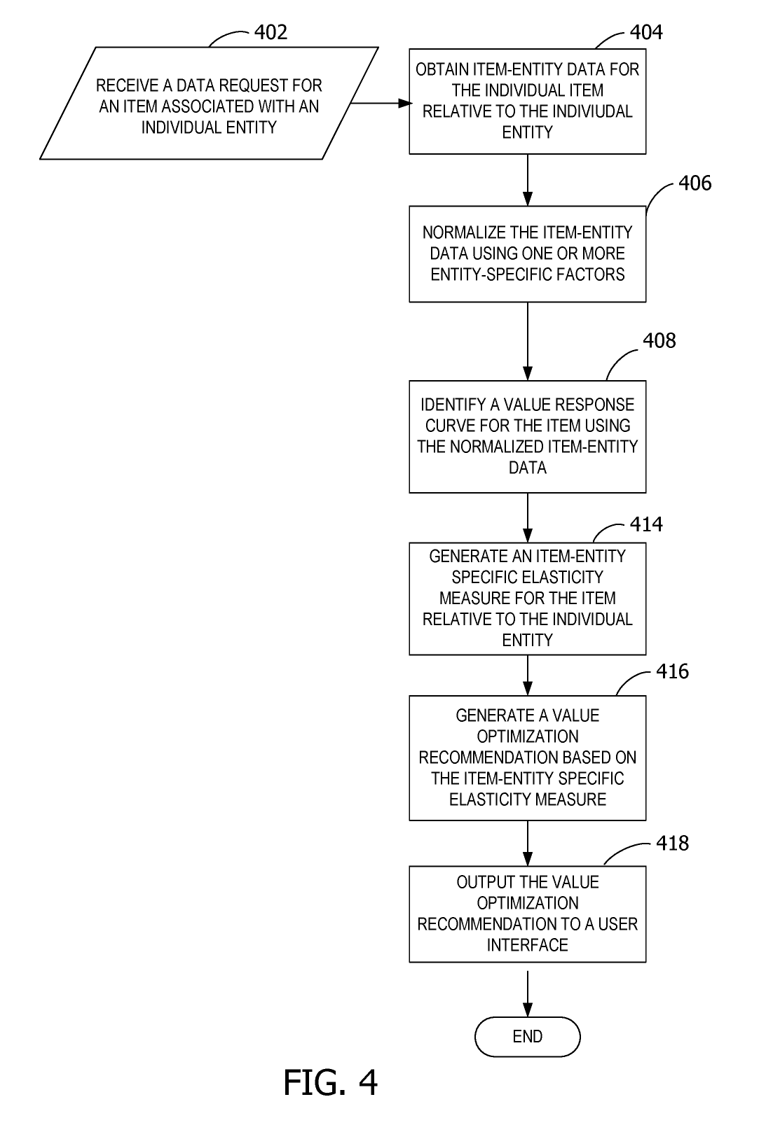

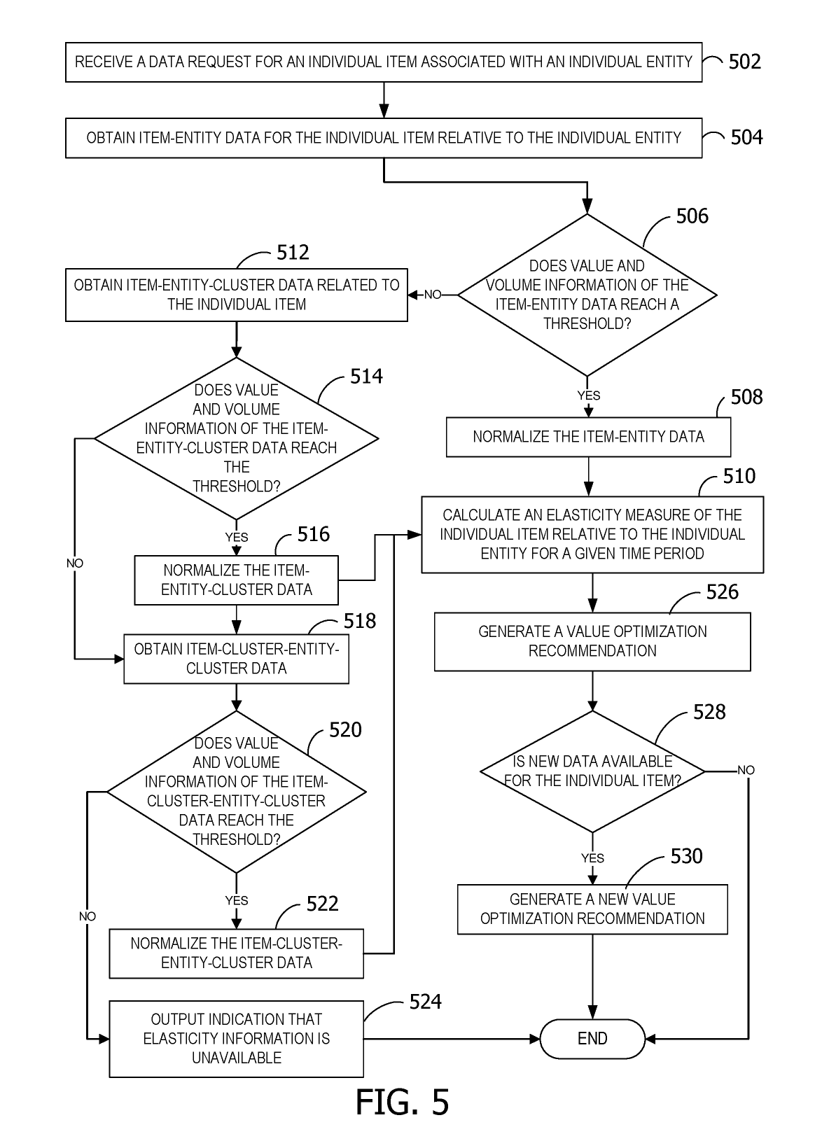

In some examples, the computing device has at least one processor 104, a memory area 106, and at least one user interface. The processor includes any quantity of processing units, and is programmed to execute computer-executable instructions for implementing aspects of the disclosure. The instructions may be performed by the processor or by multiple processors within the computing device, or performed by a processor external to the computing device. In some examples, the processor is programmed to execute instructions such as those illustrated in the figures (e.g., FIG. 4 and FIG. 5).

In some examples, the processor represents an implementation of analog techniques to perform the operations described herein. For example, the operations may be performed by an analog computing device and/or a digital computing device.

The computing device further has one or more computer readable media such as the memory area. The memory area includes any quantity of media associated with or accessible by the computing device. The memory area may be internal to the computing device (as shown in FIG. 1), external to the computing device (not shown), or both (not shown). In some examples, the memory area includes read-only memory and/or memory wired into an analog computing device.

The memory area stores, among other data, one or more applications. The applications, when executed by the processor, operate to perform functionality on the computing device. Exemplary applications include optimization environment 108, which may represent an application for entity-specific processing of data requests for generating elasticity estimations and value optimization recommendations. The applications may communicate with counterpart applications or services such as web services accessible via communication network 110. For example, the applications may represent downloaded client-side applications that correspond to server-side services executing in a cloud. The memory area may store data sources 112, which may represent data stored locally at memory 106, data access points stored locally at memory area 106 and associated with data stored remote from computing device 102, or any combination of local and remote data.

The memory area further stores one or more computer-executable components. Exemplary components include a user interface component. The user interface component 114, when executed by the processor 104 of computing device 102, cause the processor 104 to perform operations, including to receive user selections, such as data requests, during user interaction with optimization environment 108, for example.

In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way. In another example, the user may input commands or manipulate data by providing a gesture detectable by the user interface component, such as a touch or tap of a touch screen display or natural user interface.

In some examples, a user 116 may interact with the system of computing device 102 via communications network 110 using interface 118. Interface 118 may be a user interface component of another computing device communicatively coupled to communication network 110, for example. In some examples, interface 118 may provide an instance of optimization environment 108 for receiving user input and displaying content to the user, while elasticity estimation and value optimization recommendation operations are performed on the backend at computing device 102.

Optimization environment 108 provides components for entity-specific data request processing associated with an item to generate value optimization recommendations for the item at an item-entity level. In some examples, optimization environment 108 includes entity-specific normalization module 120, item-entity elasticity estimation module 122, and item-entity value optimization module 124.

Entity-specific normalization module 120 is a component of optimization environment 108 that receives data requests for items associated with a specific or individual entity, obtains item-entity data corresponding to the item and the individual entity identified in the data request, identifies one or more entity-specific factors associated with the item-entity data, and normalizes the item-entity data based on the identified entity-specific factors.

Entity-specific factors refer to specific factors associated with the individual entity that affect or otherwise impact the data for a specific item relative to that specific entity. For example, entity-specific factors may include, without limitation, entity format, entity size, entity region, volume of sales, entity location, or entity inventory.

Entity format may refer to a variable type of entity within a larger entity environment, such as a type of branded store within the branded environment. For example, a company may have variable formats or types of stores within the company of stores, such as a small neighborhood store format, a large megastore format, an urban format, a rural format, a domestic format, an international format, and so forth. The format of the entity may have an impact on the data related to an item sold or otherwise offered for sale at that specific entity.

Likewise, entity size may be another entity-specific factor that impacts the data related to an item associated with that specific entity. As used herein, entity size may refer to an available square footage of retail space for that entity location, rather than a format of the entity. Entity region may refer to the geo-physical location of a specific entity. As used herein, entity location may refer to a type of environment associated with the geo-physical location of a specific entity, such as, without limitation, rural environment, urban environment, residential environment, coastal environment, land-locked environment, and the like.

Entity inventory refers to information on other items, products, or services provided by or offered at the specific entity, which may impact data related to the specific item that is the subject of the data request. These entity-specific factors are identified by entity-specific normalization module 120 for the individual entity associated with the item identified by the data request, and used to normalize the item-entity data, for example, by taking into account where a store is located, what size or type of store it is, and normalizing sales data related to the item based on that information. In other words, normalizing the item-entity data is not directed at modifying the structure of the data, but rather adjusting values of the data using variable weights of the various entity-specific factors.

Item-entity elasticity estimation module 122 is a component of optimization environment 108 that receives the normalized item-entity data from entity-specific normalization module 120, identifies a value response curve for the item associated with the data request, identifying the best fit curve, and generating an item-entity specific elasticity measure for the item associated with the data request. Item-entity elasticity estimation module 122 identifies the best fit curve, or best fit value response curve, by running a number of models against the normalized item-entity data, using a number of data points from the normalized data and a R̂2 value (statistical measure of curve fitness) to determine which model is the best fit for providing the elasticity estimation measure. Item-entity elasticity estimation module 122 may also receive a lost sale factor from a lost sale module (not shown), the lost sale factor associated with the item of the data request, and used by item-entity elasticity estimation module 122 when calculating the elasticity estimation measure. A lost sale factor may include information associated with the item and the individual item relative to a loss, such as identifying whether a product was available or unavailable at a product placement location within the entity at a time that a customer was looking for the item, for example. Other lost sale information may include statistical calculations based on sales of similar items at the same entity, or sales of the same or similar items at similar entities, a determination of a normal rate of sale for an item calculated with an actual rate of sale, information on a loss of demand, shelf gap data (inventory on hand but not accessible by the consumer), and so forth.

Item-entity value optimization module 124 receives the item-entity specific elasticity measure from item-entity elasticity estimation module 122, and uses that measure to calculate a value optimization recommendation for the item specific to the associated individual entity. In other words, the generated value optimization recommendation is specific to that item and that entity, or is an item-entity specific recommendation. The value optimization recommendation is a directional indicator, or an indication of a direction that an adjustment to the current value associated with the item should take in order to optimize the valuation for that item at that entity. For example, a direction indicator may be an indication that an item price should increase, decrease, or be maintained for a given time period, in order to be an optimal or fair pricing for that item at that entity location.

As described herein, the optimization environment 108 provides a system that determines the behavior of value change on sales volume at an item-store level by using historical item value data, historical volume sales data, and information specific to that item and store, such as promotions, time period of sales, seasonality, similar items sales data, market value inflation, and wage inflation, which may be stochastic due to variation in demand by day. Aspects of this disclosure enable estimation of a brand-specific or retail environment-specific elasticity and fair value conditions at an item-store level for that specific brand of stores or company. By determining whether product behavior is elastic or inelastic at a specific store based on finding the appropriate value response curve for the data that accounts for seasonality, value inflation, wage inflation, lost sales, duration of value validity, time, and behavior of similar items, aspects of the disclosure then dynamically adjust the value response curves in response to any new data dynamically obtained or received, optimal value recommendations may be generated directed at increasing, decreasing, or maintaining a current value of an item to achieve fair valuation of the item at a specific entity based on existing market conditions and elasticity at a given time.

Different stores or entities in different locations may have different valuations on the same item, which may be driven by elasticity in some examples, which itself is driven by how sensitive a customer base associated with that store is to a change in value and how such a change in value affects sales of the item at that specific location. In addition to value, other factors may impact item sales, such as inflation, seasonality, and so forth. By identifying elasticity of an item at an item-store level, recognizing that each item at each store may have a different value of elasticity, using entity-specific factors, an optimal valuation recommendation is provided at an item-entity level. Additionally, by normalizing the item-entity data based on factors such as region, format, inflation, seasonality, time period of an item value, markdown data, and so forth, the best fit value response curve may be identified for the item-entity data in order to calculate the item-entity elasticity estimation.

In some examples, a threshold level of data may not be available for a specific item associated with a specific entity. For example, an item at a given store may not have been through a valuation change, or the store may be a new store with limited or no historical data for that location. Given a scenario where the item-entity data does not reach a threshold level in order to process for elasticity estimation and value optimization recommendation, the optimization environment may look for data at the next level, that is an item-entity-cluster level. In this example, at the item-entity-cluster level, a cluster of stores is identified for the entity of the data request. A cluster of stores may be two or more stores grouped together based on one or more attributes of the two or more stores. For example, the attributes may include, without limitation, region, size, type or format, sales volume, location, inventory, and the like. The number of stores in a given cluster may vary, and may be dependent on the region or market of the retail environment. In this example, the item-entity-cluster data is normalized first at an item-entity level, where applicable, for each entity in the cluster that provides the threshold level of item-entity data, and then the normalized item-entity data for each applicable store of the cluster is aggregated to generate normalized item-entity-cluster data for elasticity calculation.

In an exemplary scenario, where the item-entity-cluster data does not reach the threshold level for data processing by the optimization environment, the next level is the item-cluster-entity-cluster level, in which a cluster of items is identified for a cluster of entities. In this example, the cluster of entities may be similar to the entity cluster of the item-entity-cluster level, with additional data provided by identifying a cluster of items for the cluster of entities. The cluster of items may be two or more items grouped together based on a number of attributes, such as, without limitation, value, cost, location within an entity (product placement), product group, sales volume, item size, and the like. The item-cluster-entity-cluster data is normalized and aggregated to generate normalized item-cluster-entity-cluster data for elasticity calculation. If the item-cluster-entity-cluster data still does not reach the threshold for data processing by optimization environment 108, an indication may be returned that elasticity information is unavailable for the given item. In such scenarios, a theoretical elasticity may be associated with an item at an entity (at the item-entity level), based on the below formula:

$$Elasticity = \frac{{P}_{max} + Cost}{{P}_{max} - Cost} , \\ where {P}_{max} is the range of price points , \\ {P}_{max} ∈ \{ 1.5 P , 1.75 P , 2 P , {P}_{max}^{c} \} \qquad Formula 1$$

and Pₘₐₓ^{c} is the price of the costliest item in the item cluster, P is the current price of the item, and cost is the total landed cost of the item in that entity.

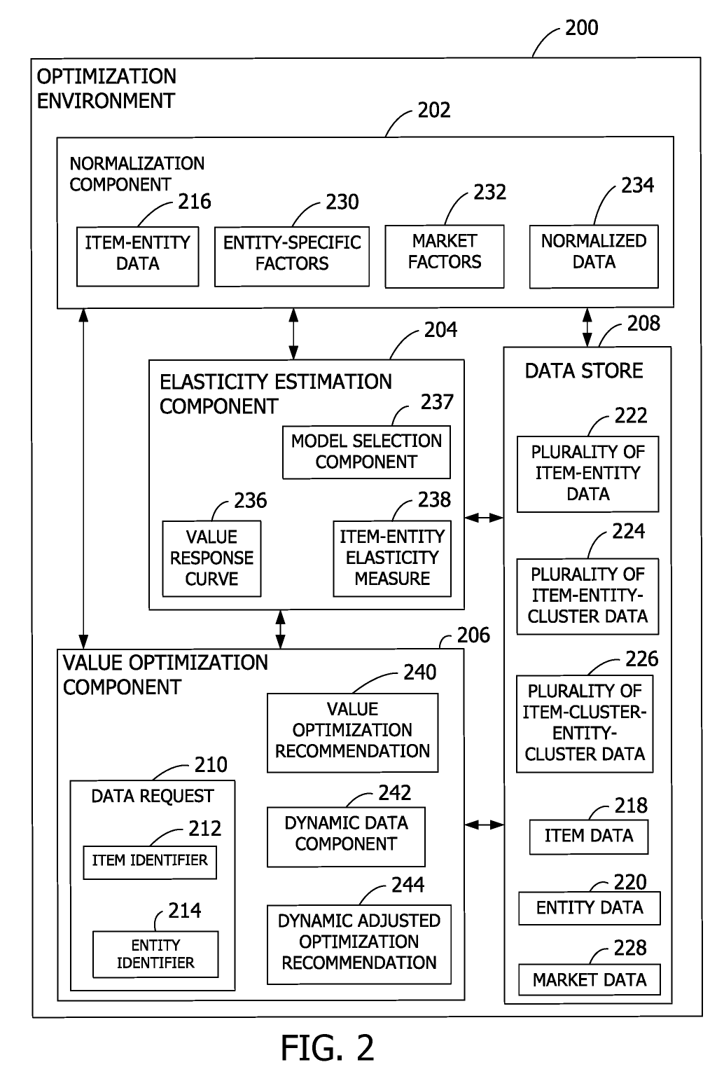

FIG. 2 is an exemplary block diagram illustrating an optimization environment for entity-specific elasticity estimations and value recommendations. Optimization environment 200 is an illustrative example of one implementation of optimization environment 108 in FIG. 1. Optimization environment 200 includes normalization component 202, elasticity estimation component 204, value optimization component 206, and data store 208.

Value optimization component 206 may receive data request 210, which includes item identifier 212 and entity identifier 214. Item identifier 212 may be a unique identifier of an item, product, or service, such as an item name or item number, for example. Entity identifier 214 may be a unique identifier of a specific individual entity, such as a specific store within a chain of stores, for example. Value optimization component 206 may send data request 210 to normalization component 202 in order to normalize the data for elasticity calculations before generating a value optimization recommendation for the item and entity identified in data request 210.

Normalization component 202 receives data request 210 and uses item identifier 212 and entity identifier 214 to locate and obtain item-entity data specific to the item and entity identified in data request 210. Normalization component 202 may obtain item-entity data from a data store, such as data store 206, in one example.

Data store 206 may be implemented within optimization environment 200, as depicted in the illustrative example of FIG. 2, or alternatively may be located remote from and communicatively coupled to optimization environment 200 (not shown). Normalization component 202, elasticity estimation component 204, and value optimization component 206 may access data store 206 to obtain information relative to data request 210, such as item-entity data 216.

Data store 206 may include, without limitation, item data 218, entity data 220, plurality of item-entity data 222, plurality of item-entity-cluster data 224, plurality of item-cluster-entity-cluster data 226, and market data 228. Item data 218 may include information on individual items, such as attributes of the individual items, historical data associated with the individual items, and the like. Entity data 220 may include information on individual entities, such as attributes of the individual entities, historical data associated with the individual entities, and the like. Item-entity data 222 may include information associated with individual items relative to individual entities. In some examples, when normalization component 202 receives data request 210, normalization component 202 may use item identifier 212 and entity identifier 214 to determine whether item-entity data for the specific item and entity is already stored in plurality of item-entity data 222, and if so, retrieve the relevant item-entity data for data request 210. If stored item-entity data is not available from plurality of item-entity data 222 for the specific item and entity, normalization component may locate relevant information for the specific item and entity from item data 218 and entity data 220, process the relevant information into item-entity data 216, and optionally store item-entity data 216 at plurality of item-entity data 222 for future use.

Plurality of item-entity-cluster data 224 may include information associated with individual items relative to a cluster of individual entities. Plurality of item-cluster-entity-cluster data 226 may include information associated with a cluster of individual items relative to a cluster of individual entities. Market data 228 may include information about market factors relative to one or more time periods, market factors relative to one or more regions, market factors relative to one or more items or item types, and the like.

Normalization component 202 uses entity identifier 214 of data request 210 to identify one or more entity-specific factors 230 to use in normalizing item-entity data 216. Optionally, normalization component 202 may determine one or more market factors 232 using market data 228, and may include market factors 232 and entity-specific factors 230 when processing item-entity data 216 to generate normalized data 234. Normalized data 234 may be normalized item-entity data, normalized item-entity-cluster data, normalized item-cluster-entity-cluster data, or any combination of the foregoing.

Elasticity estimation component 204 obtains or receives normalized data 234 from normalization component 202, and process normalized data 234 against a number of models to determine value response curve 236 for the item identified by data request 210. Elasticity estimation component 204 runs the normalized data against the number of models to determine a number of data points for the normalized data, and based on the number of data points determines which one or more of the models is/are the best fit for the normalized data. The models used by elasticity estimation component 204 may include, without limitation, a linear model, a log linear model, a power model, a logit model, or any other suitable model. Each model may have an associated data point threshold, which may be a minimum number of data points that are to be present in the data in order for the model to be a fit, or optimal fit, for the data. For example, a linear model may have a minimum threshold of three data points, a log linear model may have a minimum threshold of four data points, a power model may have a minimum threshold of five data points, and a logit model may have a minimum threshold of five data points. In this example, if elasticity estimation component 204 processes normalized data 234 and determines the number of data points is four, normalized data 234 may be run against both the linear and the log linear models, because the minimum threshold is satisfied for both of these models, but may not be run against the power and logit models because the minimum threshold is not satisfied. In another example, where more than five data points are identified, all four models may be run against the data. In yet another example, if a determination is made that three data points are available, the linear model may be used to determine the value response curve.

In some example, where more than one model may be available at any level, a choice of model is made by model selection component 237 based on R square values, selecting a model returning a higher R square value, signifying a best fit. Elasticity estimation component 204 may then use the value response curve suggested by the value response curve selection component.

Elasticity estimation component 204 uses value response curve 236 to calculate item-entity elasticity measure 238 for the specific item and entity identified in data request 210. Value optimization component 206 uses item-entity elasticity measure 238 to generate value optimization recommendation 240. Value optimization recommendation 240 may be an indicator of a direction of valuation adjustment for the item at the entity identified in data request 210. For example, value optimization recommendation 240 may indicate that the current value of the item at that entity should be increased, decreased, or should remain the same.

Value optimization component 206 may also include dynamic data component 242, or optionally may be coupled to a dynamic data component implemented remote from value optimization component 206. Dynamic data component 242 may dynamically pull, or otherwise dynamically obtain, data associated with items and entities as new data is available. As new data is available, dynamic data component 242 may provide the new data to value optimization component 206, which may process the new data as described above to generate dynamic adjusted optimization recommendation 244. In this way, examples of the disclosure may provide dynamic value optimization recommendations using the most recent data available to provide optimal fair valuation indications for an item associated with a specific entity.

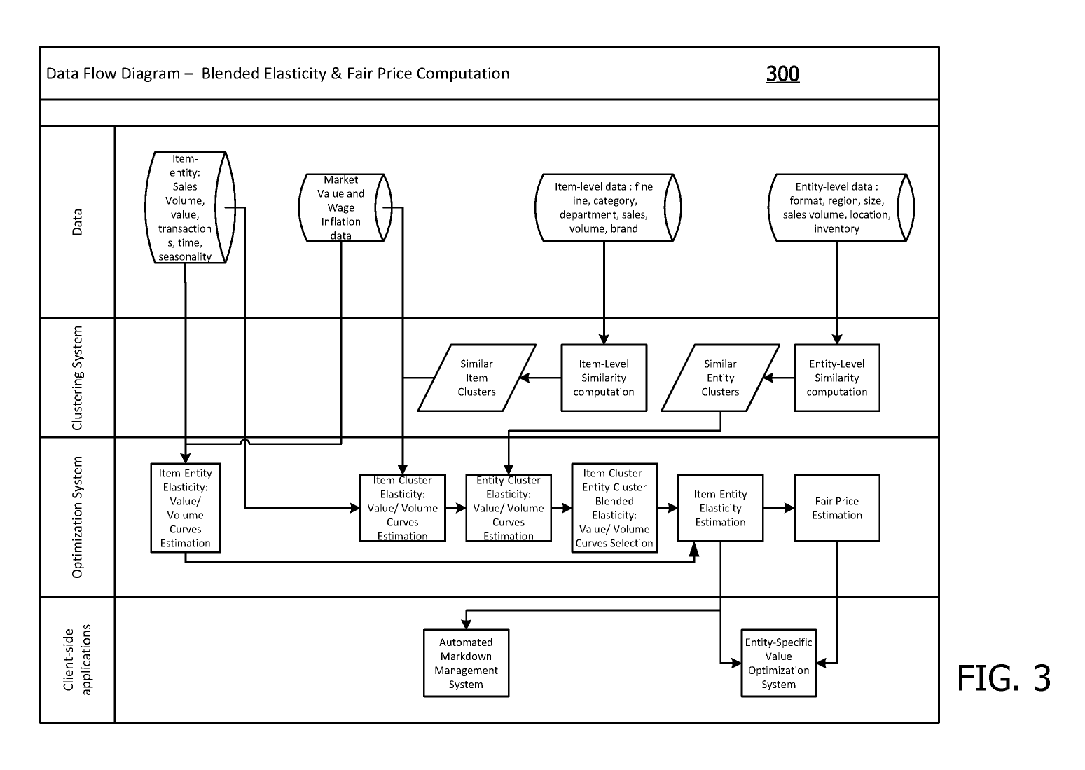

FIG. 3 is an exemplary flow diagram illustrating network communication between components and data flow within an optimization environment for entity-specific value optimization. Optimization environment 310 may be an illustrative example of one implementation of optimization environment 108 in FIG. 1 and/or optimization environment 200 in FIG. 2.

As depicted in this illustrative data flow, item-entity data for an individual item associated with an individual entity, such as sales volume, valuation, transaction information, time, seasonality, and so forth, may be available in a database for processing along with market data to generate an item-entity elasticity estimation measure. The item-entity elasticity estimation is used to determine a fair valuation estimation for the item associated with the individual entity. The elasticity estimation and the fair valuation estimation may both be output to or by an entity-specific value optimizations system, which may be a client-side application in some examples.

In some examples, the optimization system may determine that the available item-entity data does not reach a threshold level for elasticity estimation processing. In these examples, item-level data, such as fine line, category, department, sales, volume, brand, and other such information about specific items, may be used to identify or compute item-level similarity between two or more items, generating similar item clusters, which may then be used as item-cluster data in elasticity estimation computations. Likewise, entity-level data, such as format, region, size, sales volume, location, inventory, and other such information about specific entities, may be used to identify or compute entity-level similarity between two or more entities, generating similar entity clusters, which may then be used as entity-cluster data in elasticity estimation computations. At whichever level available data reaches a threshold, whether item-entity level, item-entity-cluster level, or item-cluster-entity-cluster level, the data may then be normalized and an elasticity estimation computed by the optimization system.

Optionally, item-entity elasticity estimations may be output to an automated markdown management system for automatic valuation adjustments at a client-side application, for example.

FIG. 4 is an exemplary flow chart illustrating operation of the computing device to generate a value optimization recommendation for an individual item relative to an individual entity. The exemplary operations presented in FIG. 4 may be performed by one or more components described in FIG. 1 or FIG. 2, for example.

The process receives a data request for an item associated with an individual entity at operation 402. The data request is received by a component of an optimization environment, for example. The data request may include an item identifier and an entity identifier of a specific, unique entity.

The process obtains item-entity data for the individual item relative to the individual entity at operation 404. The data obtained may be specific both to item and the individual entity, and further may be specific to a given time period, in some examples.

The process normalizes the item-entity data using one or more entity-specific factors at operation 406. The entity-specific factors may include, for example, entity format, entity size, entity region, volume of sales, entity location, or entity inventory. Normalizing the data does not refer to the structure of the data, but rather adjusting the data itself based on variable weights of the various entity-specific factors. For example, how many items were sold, at which location, at what price, scanned at what checkout device/location, of what type or format store, and so on. In an illustrative example, where ten units of an item sold at $1.02 at a first time period, and zero units sold at a second time period when the price was marked down to $1.00/unit, yet twenty units sold at $1.04 at a third time period, the factors of where the store is located, during what time of year each of the three time periods fell (seasonality), how long the item was listed at each of the differing price points, and so forth impact how the raw data is processed to normalize the data for elasticity estimation calculations. The normalization is based on entity-specific data, thus generating item-entity specific normalized data.

The process identifies a value response curve for the item using the normalized item-entity data at operation 408. The normalized data is processed to identify a number of data points, and the number of data points drives the selection of one or more models to run that normalized data against, based on minimum data point thresholds of the various models. The process generates an item-entity specific elasticity measure for the item relative to the individual entity at operation 410, based on the identified value response curve. The process generates a value optimization recommendation based on the item-entity specific elasticity estimation at operation 412, and outputs the value optimization recommendation to a user interface, with the process terminating thereafter.

FIG. 5 is an exemplary flow chart illustrating operation of the computing device to dynamically generate value optimization recommendations. The exemplary operations presented in FIG. 5 may be performed by one or more components described in FIG. 1 or FIG. 2, for example.

The process receives a data request for an item associated with an individual entity at operation 502. The data request is received by a component of an optimization environment, for example. The data request may include an item identifier and an entity identifier of a specific, unique entity.

The process obtains item-entity data for the individual item relative to the individual entity at operation 504. The data obtained may be specific both to item and the individual entity, and further may be specific to a given time period, in some examples.

The process determines whether value and volume information of the item-entity data reaches a threshold at operation 506. If the process determines that the value and volume information reaches the threshold, the process normalizes the item-entity data at operation 508. The process then calculates an elasticity measure of the individual item relative to the individual entity for a given time period at operation 510.

If the process determines that the value and volume information does not reach the threshold, the process obtains item-entity-cluster data related to the individual item at operation 512. The process determines whether the value and volume information of the item-entity-cluster data reaches the threshold at operation 514. If the process determines that the value and volume information of the item-entity-cluster data reaches the threshold, the process normalizes the item-entity-cluster data at operation 516, then proceeds to operation 510. If the process determines that the value and volume information of the item-entity-cluster data does not reach the threshold, the process obtains item-cluster-entity-cluster data at operation 518.

The process determines whether the value and volume information of the item-cluster-entity-cluster data reaches the threshold at operation 520. If the process determines that the value and volume information of the item-cluster-entity-cluster data reaches the threshold, the process normalizes the item-cluster-entity-cluster data at operation 522 and proceeds to operation 510. If the process determines that the value and volume information of the item-cluster-entity-cluster data does not reach the threshold, the process outputs an indication that elasticity information is unavailable for the individual item at operation 524, with the process terminating thereafter.

The process uses the calculated elasticity measure from operation 510 to generate a value optimization recommendation at operation 526. The process may then determine if new data is available for the individual item at operation 528. If the process determines that new data is not available, the process may terminate thereafter. If the process determines that new data is available, the process may generate a new value optimization recommendation, with the process terminating thereafter.

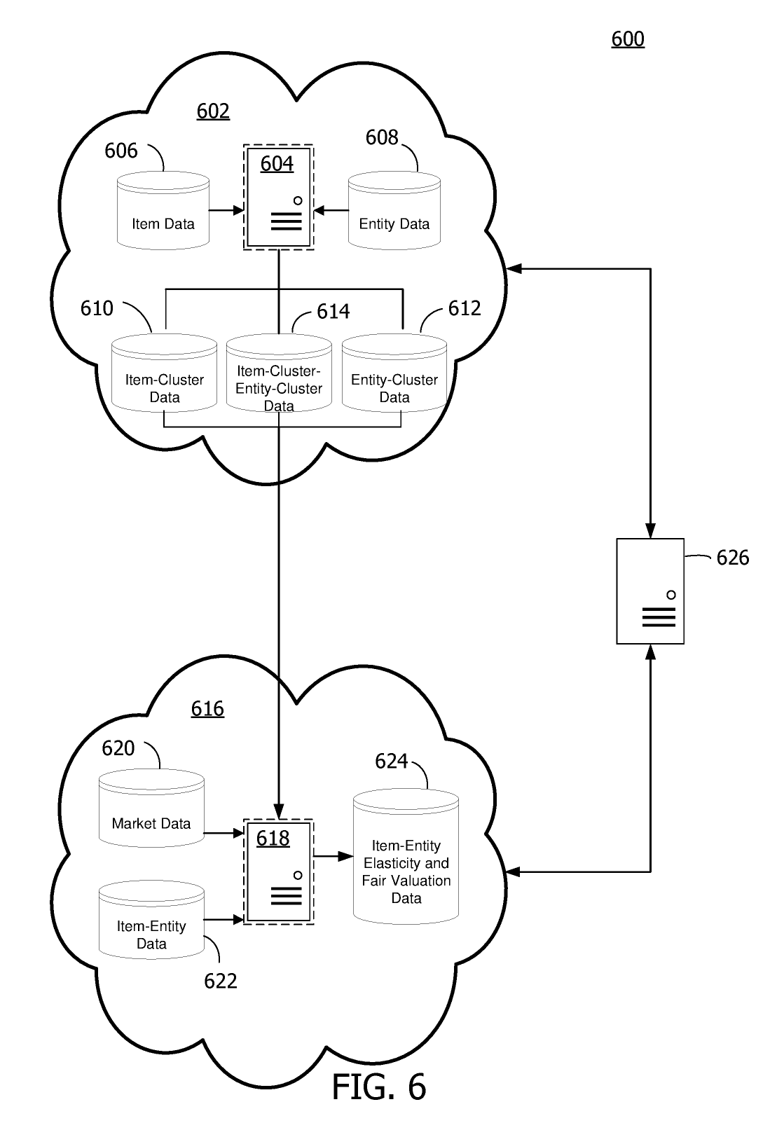

FIG. 6 is an exemplary diagram illustrating an optimization environment operating as a cloud-based service. Optimization environment 600 may be an illustrative example of optimization environment 108 in FIG. 1 and/or optimization environment 200 in FIG. 2.

Optimization environment 600 may be implemented in a cloud-based environment, with one or more operations performed in the cloud, for example. In this illustrative example, cloud location 602 may include virtual server 604, which may process item data 606 and entity data 608 to generate item-cluster data 610, entity-cluster data 612, and item-cluster-entity-cluster data 614.

Cloud location 616 may be communicatively coupled to cloud location 602, via a communication network, or other network, to receive and/or obtain cluster data, item data, and entity data. Virtual server 618 may provide optimization operations, such as those depicted in FIG. 4 and FIG. 5, for example, to process the data pertaining to individual items and individual entities, or clusters thereof, to generate elasticity estimations and valuation recommendations. Market data 620 may be used in conjunction with item-entity data 622 to generate item-entity elasticity and fair valuation data 624, which may be output to a client-side value optimization system residing on a client-side server, such as server 626 in this illustrative example.

### ADDITIONAL EXAMPLES

In some examples, elasticity is used to determine what a fair value or price may be for a specific item at a specific location, not towards what a value amount should be set at, but rather if a value adjustment should be made to increase or decrease a current value or price associated with an item at a specific entity, or if a current value should be maintained for a given time period. In some instances, an increase in value of an item at one location may result in higher sales than a decrease in value at another location, based on various entity-specific factors, such as inflation, region, and so on, which is why normalizing the data for item-entity specific elasticity calculations leads to an entity-specific value recommendation for a specific entity, and an item-entity level. This provides a highly customized valuation recommendation and elasticity estimation for an individual entity or store location, that a company of stores may use to variably adjust valuations across different store locations in order to maximize fair valuations across the company.

Alternatively, or in addition to the other examples described herein, examples include any combination of the following:
dynamically adjusts the identified value response curve for the item associated with the individual entity as new data corresponding to the item and the individual entity is received;
generates an adjusted value optimization recommendation based on the dynamic adjustment;
wherein the elasticity estimation module is further configured to identify the value response curve for the item associated with the individual entity based on at least one of a linear, log linear, power, or logit model;
wherein the elasticity estimation module is further configured to identify the value response curve for the item associated with the individual entity using at least one of item-cluster data, entity-cluster data, or any combination of the item-entity data, item-cluster data, or entity-cluster data;
wherein the item-cluster data includes a plurality of item data aggregated based at least in part on item attributes;
wherein the entity-cluster data includes a plurality of entity data aggregated based at least in part on entity attributes;
wherein the value optimization recommendation is a directional indicator that comprises an indication of whether an item value is to be increased, decreased, or maintained for a given time;
a lost sale component, the lost sale component configured to provide an indication to the elasticity estimation module as to whether a lost sale factor applies to the item associated with the individual entity for a given time period, such that the determined elasticity measure for the item is calculated at least in part using the lost sale factor;
wherein the individual entity is a specific retail store location;
responsive to a determination that the value and volume information of the item-entity data does not reach the threshold, obtaining item-entity-cluster data related to an individual item associated with a cluster of individual entities, the cluster of individual entities including two or more individual entities grouped together based on a number of attributes associated with the two or more individual entities, the item-entity-cluster data including other value and volume information corresponding to the individual item associated with the cluster of individual entities;
determining whether the other value and volume information of the item-entity-cluster data reaches the threshold;
responsive to a determination that the other value and volume information of the item-entity-cluster data reaches the threshold, normalizing the other value and volume information using one or more clustered entity-specific factors associated with the cluster of individual entities;
calculating the elasticity measure of the individual item for the individual entity corresponding to the given time period using the normalized other value and volume information;
responsive to a determination that the other value and volume information of the item-entity-cluster data does not reach the threshold, obtaining item-cluster-entity-cluster data related to a cluster of individual items associated with the cluster of individual entities, the cluster of individual items including two or more individual items grouped together based on a number of attributes associated with the two or more individual items, the item-cluster-entity-cluster data including clustered value and volume information associated with the cluster of individual items relative to the cluster of individual entities;
determining whether the clustered value and volume information of the item-cluster-entity-cluster data reaches the threshold;
responsive to a determination that the clustered value and volume information of the item-cluster-entity-cluster data reaches the threshold, normalizing the clustered value and volume information using the one or more clustered entity-specific factors associated with the cluster of individual entities;
calculating the elasticity measure of the individual item for the individual entity corresponding to the given time period using the normalized clustered value and volume information;
responsive to a determination that the clustered value and volume information of the item-cluster-entity-cluster data does not reach the threshold, outputting an indication that elasticity information is unavailable for the individual item associated with the individual entity;
wherein the number of attributes associated with the two or more individual entities of the cluster of individual entities include at least one of entity format, entity size, entity region, volume of sales, entity location, or entity inventory;
wherein the one or more entity-specific factors include at least one of entity format, entity size, entity region, volume of sales, entity location, or entity inventory;
a lost sale component that provides an indication to the elasticity estimation module as to whether a lost sale factor applies to the item associated with the individual entity for the given time period, such that the determined elasticity measure for the item is calculated at least in part using the lost sale factor;
obtains the item-entity data via a communication network coupled to the computer, the item-entity data including valuation information corresponding to the item and the individual entity and volume information corresponding to sales of the item at the individual entity for the given period of time;
obtains market data relative to at least one of the item or the individual entity;
normalizes the valuation information and the volume information based at least in part on the market data;
outputs the normalized item-entity data to the elasticity estimation component to calculate the elasticity measure of the item for the individual entity corresponding to the given time period;
dynamically receives new data related to the item and the individual entity corresponding to a new time period;
generates a new value optimization recommendation for the new time period based at least in part on the dynamically received new data;
wherein the value optimization recommendation is a directional indicator that includes an indication of whether to increase, decrease, or maintain an item value for the given period of time.

In some examples, the operations illustrated in FIG. 4 and FIG. 5 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

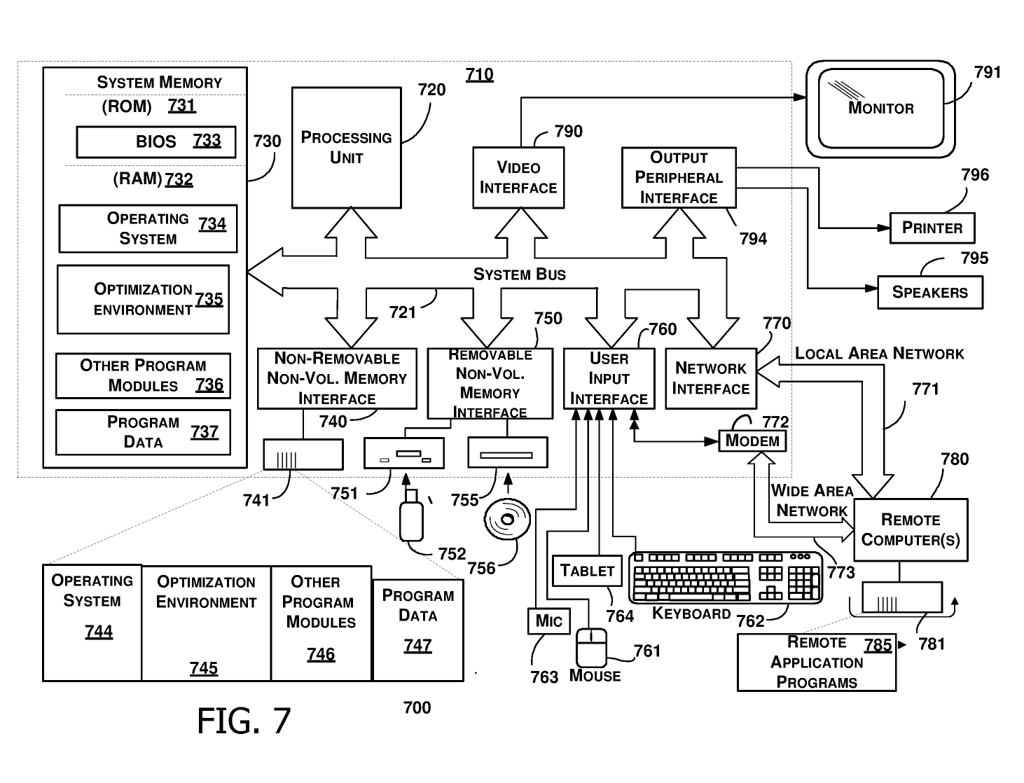

FIG. 7 illustrates an example of a suitable computing and networking environment 700 on which the examples of FIG. 1 may be implemented. The computing system environment 700 is only one example of a suitable computing environment and is not intended to suggest any limitation as to the scope of use or functionality of the disclosure. Neither should the computing environment 700 be interpreted as having any dependency or requirement relating to any one or combination of components illustrated in the exemplary operating environment 700.

The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 7, an exemplary system for implementing various aspects of the disclosure may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media may be any available media that may be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 731 and 732 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 710. Computer storage media does not, however, include propagated signals. Rather, computer storage media excludes propagated signals. Any such computer storage media may be part of computer 710.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs, such as optimization environment 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a universal serial bus (USB) port 751 that provides for reads from or writes to a removable, nonvolatile memory 752, and an optical disk drive 755 that reads from or writes to a removable, nonvolatile optical disk 756 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and USB port 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, optimization environment 745, other program modules 746 and program data 747. Note that these components may either be the same as or different from operating system 734, optimization environment 735, other program modules 736, and program data 737. Operating system 744, optimization environment 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel may be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

The examples illustrated and described herein as well as examples not specifically described herein but within the scope of aspects of the disclosure constitute an exemplary entity-specific value optimization environment. For example, the elements illustrated in FIG. 1 and FIG. 2, such as when encoded to perform the operations illustrated in FIG. 4 and FIG. 5, constitute exemplary means for receiving a data request for an item associated with an individual entity, exemplary means for normalizing item-entity data, exemplary means for estimating an elasticity measure for the item using the normalized item-entity data, and exemplary means for generating a value optimization recommendation based on the elasticity estimation for the item at an item-entity level.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for entity-specific value optimization, the system comprising:
an interface coupled to a communication network;
at least one processor coupled to the interface via the communication network;
a value optimization module, implemented on the at least one processor, that receives a data request for an item, the data request associated with an individual entity;
a normalization module communicatively coupled to the price optimization module that:
obtains item-entity data corresponding to the item and the individual entity;
identifies one or more entity-specific factors associated with the item-entity data; and
normalizes the item-entity data based on the one or more entity-specific factors; and
an elasticity estimation module, implemented on the at least one processor, that:
receives the normalized item-entity data for the data request from the normalization module;
identifies a value response curve for the item associated with the data request using the normalized item-entity data; and
generates an item-entity specific elasticity measure for the item associated with the data request, the value optimization module further generating a value optimization recommendation based on the determined item-entity specific elasticity measure.

2. The system of claim 1, wherein the value optimization module further:
dynamically adjusts the identified value response curve for the item associated with the individual entity as new data corresponding to the item and the individual entity is received; and
generates an adjusted value optimization recommendation based on the dynamic adjustment.

3. The system of claim 1, wherein the elasticity estimation module is further configured to identify the value response curve for the item associated with the individual entity based on at least one of a linear, log linear, power, or logit model.

4. The system of claim 1, wherein the elasticity estimation module is further configured to identify the value response curve for the item associated with the individual entity using at least one of item-cluster data, entity-cluster data, or any combination of the item-entity data, item-cluster data, or entity-cluster data.

5. The system of claim 1, wherein the item-cluster data includes a plurality of item data aggregated based at least in part on item attributes.

6. The system of claim 1, wherein the entity-cluster data includes a plurality of entity data aggregated based at least in part on entity attributes.

7. The system of claim 6, wherein the value optimization recommendation is a directional indicator that comprises an indication of whether an item value is to be increased, decreased, or maintained for a given time.

8. The system of claim 1, wherein the elasticity estimation module further comprises:
a lost sale component, the lost sale component configured to provide an indication to the elasticity estimation module as to whether a lost sale factor applies to the item associated with the individual entity for a given time period, such that the determined elasticity measure for the item is calculated at least in part using the lost sale factor.

9. The system of claim 1, wherein the individual entity is a specific retail store location.

10. A method for entity-specific value optimization implemented on at least one processor, comprising:
receiving a data request for an individual item associated with an individual entity via a communication network coupled to the at least one processor;
obtaining item-entity data for the individual item relative to the individual entity, the item-entity data including value and volume information;
determining whether the value and volume information of the item-entity data reaches a threshold;
responsive to a determination that the value and volume information of the item-entity data reaches the threshold, normalizing the value and volume information using one or more entity-specific factors associated with the individual entity;
calculating an elasticity measure of the individual item relative to the individual entity corresponding to a given time period using the normalized value and volume information of the item-entity data;
generating a value optimization recommendation based at least in part on the calculated elasticity measure;
dynamically receiving new data related to the individual item associated with the individual entity corresponding to a new time period; and
generating a new value optimization recommendation for the new time period based at least in part on the dynamically received new data.

11. The method of claim 10, further comprising:
responsive to a determination that the value and volume information of the item-entity data does not reach the threshold, obtaining item-entity-cluster data related to an individual item associated with a cluster of individual entities, the cluster of individual entities including two or more individual entities grouped together based on a number of attributes associated with the two or more individual entities, the item-entity-cluster data including other value and volume information corresponding to the individual item associated with the cluster of individual entities;
determining whether the other value and volume information of the item-entity-cluster data reaches the threshold;
responsive to a determination that the other value and volume information of the item-entity-cluster data reaches the threshold, normalizing the other value and volume information using one or more clustered entity-specific factors associated with the cluster of individual entities; and
calculating the elasticity measure of the individual item for the individual entity corresponding to the given time period using the normalized other value and volume information.

12. The method of claim 11, further comprising:
responsive to a determination that the other value and volume information of the item-entity-cluster data does not reach the threshold, obtaining item-cluster-entity-cluster data related to a cluster of individual items associated with the cluster of individual entities, the cluster of individual items including two or more individual items grouped together based on a number of attributes associated with the two or more individual items, the item-cluster-entity-cluster data including clustered value and volume information associated with the cluster of individual items relative to the cluster of individual entities;
determining whether the clustered value and volume information of the item-cluster-entity-cluster data reaches the threshold;
responsive to a determination that the clustered value and volume information of the item-cluster-entity-cluster data reaches the threshold, normalizing the clustered value and volume information using the one or more clustered entity-specific factors associated with the cluster of individual entities; and
calculating the elasticity measure of the individual item for the individual entity corresponding to the given time period using the normalized clustered value and volume information.

13. The method of claim 12, further comprising:
responsive to a determination that the clustered value and volume information of the item-cluster-entity-cluster data does not reach the threshold, outputting an indication that elasticity information is unavailable for the individual item associated with the individual entity.

14. The method of claim 13, wherein the number of attributes associated with the two or more individual entities of the cluster of individual entities include at least one of entity format, entity size, entity region, volume of sales, entity location, or entity inventory.

15. The method of claim 13, wherein the one or more entity-specific factors include at least one of entity format, entity size, entity region, volume of sales, entity location, or entity inventory.

16. One or more computer storage devices having computer-executable instructions stored thereon for entity-specific value optimization, which, on execution by a computer, cause the computer to perform operations comprising:
an interface component that receives a data request for an item, the data request associated with an individual entity and corresponding to a given period of time;
a normalization component that obtains item-entity data for the item associated with the individual entity and normalizes the item-entity data based on one or more entity-specific factors associated with the individual entity;
an elasticity estimation component that determines an elasticity measure for the item associated with the individual entity using the normalized item-entity data; and
a value optimization component that generates a value optimization recommendation for the item associated with the individual entity based at least in part on the elasticity measure.

17. The one or more computer storage devices of claim 16, further comprising:
a lost sale component that provides an indication to the elasticity estimation module as to whether a lost sale factor applies to the item associated with the individual entity for the given time period, such that the determined elasticity measure for the item is calculated at least in part using the lost sale factor.

18. The one or more computer storage devices of claim 16, wherein the normalization component further:
obtains the item-entity data via a communication network coupled to the computer, the item-entity data including valuation information corresponding to the item and the individual entity and volume information corresponding to sales of the item at the individual entity for the given period of time;
obtains market data relative to at least one of the item or the individual entity;
normalizes the valuation information and the volume information based at least in part on the market data; and
outputs the normalized item-entity data to the elasticity estimation component to calculate the elasticity measure of the item for the individual entity corresponding to the given time period.

19. The one or more computer storage devices of claim 16, wherein the value optimization component further:
dynamically receives new data related to the item and the individual entity corresponding to a new time period; and
generates a new value optimization recommendation for the new time period based at least in part on the dynamically received new data.

20. The one or more computer storage devices of claim 16, wherein the value optimization recommendation is a directional indicator that includes an indication of whether to increase, decrease, or maintain an item value for the given period of time.
